(19) United States
(12) Patent Application Publication
(10) Pub. No.: US 2003/0055126 A1
(43) Pub. Date: Mar. 20, 2003

(54) Brake pad lining filler material

(76) Inventors: Jianmei Pan, Thousand Oaks, CA (US); Yngve Naerheim, Thousand Oaks, CA (US); Tony Ten-Luen Liao, South Pasadena, CA (US); Peter Min, Thousand Oaks, CA (US)

Correspondence Address: CARLSON, GASKEY & OLDS, P.C., 400 WEST MAPLE ROAD, SUITE 350, BIRMINGHAM, MI, 48009, US

(21) Appl. No.: 09/953,817

(22) Filed: Sep. 17, 2001

(51) Int. Cl. C08J 5/14

(52) U.S. Cl. 523/153; 523/155

(57) ABSTRACT

A brake pad lining composition is provided that includes a friction modifier for adjusting a coefficient of friction of the brake pad lining and a strengthener for providing structural integrity. The composition also includes a fly ash filler for increasing the volume of the brake pad lining. A binder, such as phenolic resin, holds the friction modifier, the strengthener, and the filler together. By utilizing fly ash as a filler, the cost of the brake pad may be significantly reduced. Design of the brake pad lining may be simplified and the filler used more effectively by achieving a desired ratio of fly ash and binder, and then adding the friction modifier and strengthener to systematically adjust the brake lining properties.

### BACKGROUND OF THE INVENTION

This invention relates to brake pads used in vehicle brake assemblies, and more specifically, the invention relates to a filler material for use in the brake pad linings.

Brake pads have linings that engage a rotating member, such as a brake rotor or drum, to slow the member by applying a frictional force. Typically brake pad linings employ a dozen or more constituents that are held together by a binder. Linings must be designed with several characteristics in mind, such as the coefficient of friction, thermal conductivity, strength under compressive and shear loading, and wear rates.

Because of the many constituents that have been used and their overlapping effect on the above characteristics, it is difficult to design brake pad linings. To simplify the design process, lining compositions may be analyzed in terms of four main elements. Under this analysis, brake pad linings include a strengthener to provide structural integrity, a friction modifier to adjust the friction coefficient of the lining, a binder to hold the lining together, and a filler to provide volume and wear resistance. While there is some overlapping effect between each element on the lining characteristics, each element is used to primarily affect only a few characteristics.

The filler typically accounts for the most material of the lining by volume. In the brake pad industry virtually any material that is available cheaply, such as scrap metal chips or scrap rubber, is used as a filler material. Furthermore, combinations of filler materials have typically used which complicates designing a lining having the desired characteristics. Therefore, what is needed is a filler material that is cheap with the desired characteristics for a filler and is compatible with a strengthener, friction modifier, and binder.

### SUMMARY OF THE INVENTION AND ADVANTAGES

The present invention provides a brake pad lining composition that includes a friction modifier for adjusting a coefficient of friction of the brake pad lining and a strengthener for providing structural integrity. The composition also includes a fly ash filler for increasing the volume of the brake pad lining. A binder, such as phenolic resin, holds the friction modifier, the strengthener, and the filler together. By utilizing fly ash as a filler, the cost of the brake pad may be significantly reduced. Design of the brake pad lining may be simplified and the filler used more effectively by achieving a desired ratio of fly ash and binder, and then adding the friction modifier and strengthener to systematically adjust the brake lining properties. Previously, numerous materials were used which made brake pad linings difficult to design because of the interaction of the properties of the numerous materials.

Accordingly, the above invention provides a filler material that is cheap with the desired characteristics and compatibility for a filler. Once the desired ratio of fly ash and binder is achieved, the strengthener and friction modifier may be systematically added to obtain a brake pad lining with the desired characteristics.

### BRIEF DESCRIPTION OF THE DRAWINGS

Other advantages of the present invention can be understood by reference to the following detailed description when considered in connection with the accompanying drawings wherein:

FIG. 1 is a line graph depicting the volume percentage of fly ash vs. compression stress in which fly ash is used as a filler material for a binder; and

FIG. 2 is a group of bar graphs depicting the stud wear rate, disc wear rate, and friction coefficient for several brake lining compositions using a fly ash filler.

### DETAILED DESCRIPTION OF THE PREFERRED EMBODIMENT

Previously, numerous materials were used which made brake pad linings difficult to design because of the interaction of the properties of the numerous materials. As a result, when designing linings it was difficult to change the type or amount of material to modify a particular characteristic. For example, if scrap metal chips were used as a filler, which are used primarily to increase the volume of the lining, changing the type or amount of filler would greatly affect thermal conductivity and the coefficient of friction. Furthermore, the fillers that are used are often the cheapest material available, which may change from time to time.

The present invention provides a brake pad lining composition that may be categorized into four components: a binder, a filler, a friction modifier, and a strengthener. Preferably, a single constituent or compound is used for each component. A lining characteristic is primarily affected by a single component to simplify the lining design. However, that is not to say that the multiple components do not affect the same characteristic. Rather, when attempting to achieve a desired characteristic under this analysis, one component may be changed or adjusted to achieve the desired characteristic with minimal or no change to the other components.

The friction modifier is used primarily to adjust the coefficient of friction and thermal conductivity of the brake pad lining. Preferably, the friction modifier is iron powder, graphite, or other suitable material. The strengthener is used to provide structural integrity to the lining. Preferably, the strengthener is carbon, rock wool, aluminum fibers, Kevlar fibers, or other suitable material. The filler, which is fly ash in the present invention, is used to increase the volume of the brake pad lining. Of course, it is also important that the filler have an acceptable wear rate since it is the greatest component by volume. By utilizing fly ash as a filler, the cost of the brake pad may be significantly reduced. Fly ash is a byproduct of incinerators and power plants, which must pay for its disposal. Furthermore, fly ash has desirable wear properties and is compatible with other brake lining materials. The binder holds the friction modifier, the strengthener, and the filler together. Preferably, the binder is phenolic resin, or other suitable material.

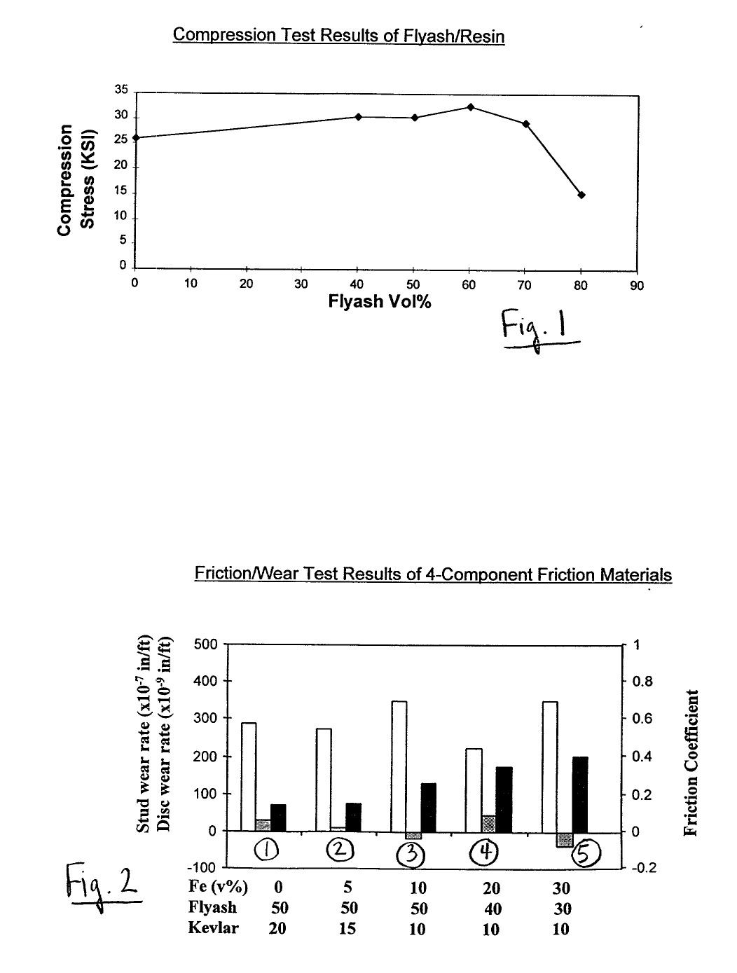

Design of the brake pad lining may be simplified and the filler used more effectively by achieving a desired ratio of fly ash and binder, and then adding the friction modifier and strengthener to systematically adjust the brake lining properties. First, the binder is combined with fly ash to form a binary compound. The compound of fly ash and binder, preferably phenolic resin, is then compression tested to determine the amount of fly ash that may be used before the compound will fail under compressive loading. The ratio of the fly ash and binder is modified if necessary to achieve the desired compression resistance, preferably less than approximately 2.5:1 when using a phenolic resin binder. As shown in FIG. 1, up to 70% by volume of fly ash may be combined with a phenolic resin before a significant decline of performance occurs under compressive loading.

Referring to FIG. 2, a friction modifier is added to the binary compound to achieve a desired coefficient of friction, and a strengthener is added to the binary compound to achieve desired strength properties. Each group of bars, 1-5, represents a lining composition. Compositions are shown using the most preferred components of a phenolic resin binder, iron powder friction modifier, and Kevlar fiber strengthener. However, it is to be understood that other materials may be used for each component. The volume percentage of each component is listed below the group of bars, with the balance of the volume being the phenolic resin binder. For example, composition 1 includes 0% by volume iron powder, 50% by volume fly ash, 20% by volume Kevlar fiber, and 30% by volume phenolic resin. Each bar from left to right indicates the friction material wear rate, the rotor wear rate, and the friction coefficient, respectively.

Preferably, the amount of the fly ash is less than approximately 50% by volume, and the amount of the phenolic resin is preferably approximately 30% by volume. Preferably, the amount of the iron is approximately between 0-30% by volume, and the amount of the Kevlar fibers is preferably approximately between 10-20% by volume. In the preferred embodiment of the invention, which is represented by composition 2, the amount of the iron is approximately 5% by volume, the amount of the Kevlar fibers is approximately 15% by volume, and the amount of fly ash and phenolic resin is approximately 50% and 30%, respectively, by volume.

The invention has been described in an illustrative manner, and it is to be understood that the terminology that has been used is intended to be in the nature of words of description rather than of limitation. Obviously, many modifications and variations of the present invention are possible in light of the above teachings. It is, therefore, to be understood that within the scope of the appended claims the invention may be practiced otherwise than as specifically described.

What is claimed is:

1. A brake pad lining composition consisting essentially of:
a friction modifier for adjusting a coefficient of friction of said brake pad lining;
a strengthener for providing structural integrity;
a fly ash filler for increasing a volume of said brake pad lining; and
a binder for holding said friction modifier, said strengthener, and said filler together.

2. The composition according to claim 1, wherein said friction modifier is selected from a group consisting of:
iron, graphite, and combinations thereof.

3. The composition according to claim 1, wherein said strengthener is selected from a group consisting of:
carbon, rock wool, aluminum fibers, Kevlar fibers, and combinations thereof.

4. The composition according to claim 1, wherein said binder is phenolic resin.

5. The composition according to claim 1, wherein said binder consists essentially of phenolic resin, and wherein the ratio of said fly ash to said phenolic resin is less than approximately 2.5:1.

6. The composition according to claim 5, wherein the amount of said fly ash is less than approximately 50% by volume.

7. The composition according to claim 6, wherein the amount of said phenolic resin is approximately 30% by volume.

8. The composition according to claim 7, wherein said friction modifier consists essentially of iron, and said strengthener consists essentially of Kevlar fibers.

9. The composition according to claim 8, wherein the amount of said iron is approximately between 0-30% by volume.

10. The composition according to claim 8, wherein the amount of said Kevlar fibers is approximately between 10-20% by volume.

11. The composition according to claim 7, wherein the amount of said iron is approximately 5% by volume, and wherein the amount of said Kevlar fibers is approximately 15% by volume.

12. A method of utilizing fly ash as a filler for a brake pad lining comprising the steps of:
a) combining a binder with fly ash to form a binary compound;
b) compression testing the binary compound;
c) modifying the ratio of the binder and fly ash within the binary compound to achieve a desired compression stress prior to failure of the binary compound;
d) adding a friction modifier to the binary compound to achieve desired a desired coefficient of friction; and
e) adding a strengthener to the binary compound to achieve desired strength properties.

13. The method according to claim 12, wherein the binder consists essentially of a phenolic resin.

14. The method according to claim 13, wherein the ratio of the fly ash to the phenolic resin is less than approximately 2.5:1.

15. The method according to claim 12, wherein the friction modifier consists essentially of iron.

16. The method according to claim 12, wherein the strengthener consists essentially of Kevlar fibers.
